(19) United States
(12) Patent Application Publication
(10) Pub. No.: US 2009/0103697 A1
(43) Pub. Date: Apr. 23, 2009

(54) Hot Water Supply Device

(76) Inventors: Shigehiko Matsuoka, Shiga (JP); Kouji Chida, Shiga (JP)

Correspondence Address: BIRCH STEWART KOLASCH & BIRCH, PO BOX 747, FALLS CHURCH, VA, 22040-0747, US

(21) Appl. No.: 11/990,303

(22) PCT Filed: Aug. 4, 2006
(86) PCT No.: PCT/JP2006/315472

§ 371 Date: Feb. 11, 2008

(51) Int. Cl. H04M 11/00

(52) U.S. Cl. 379/102.01

(57) ABSTRACT

A hot water supply device of the invention has a host remote controller 27 and a bath remote controller 20 capable of establishing a call with the host remote controller 27 by an interphone function, the bath remote controller 20 being equipped with a voice guidance function. A priority is given to the voice guidance contents outputted by the voice guidance function. When a call by the interphone function and an output command of the voice guidance by the voice guidance function concurrently occur, the voice guidance having higher order is outputted preferentially over the call. The voice guidance of the lower order is outputted after the call.

### TECHNICAL FIELD

The present invention relates to a hot water supply device.

### BACKGROUND ART

There is a hot water supply device that has a host remote controller and a bath remote controller capable of establishing a call with the host remote controller by an interphone function. That is, the host remote controller is placed in a kitchen or the like, and the bath remote controller is placed in a bathroom. Moreover, there is a bath remote controller equipped with a voice guidance function to give notice of the functioning conditions (operating conditions) of the hot water supply device (water heater) by a sound (refer to, for example, JP 2004-309062 A). It is herein noted that “rimokon” mentions a remote controller.

The device described in JP 2004-309062 A inhibits the vocalization of the voice guidance for a prescribed time from the stop of the input of a call signal after ending a call. This eliminates the trouble that, when a call ends partway during a voice guidance signal, the subsequent part of the voice guidance ends within a prescribed time, and the subsequent part is vocalized later.

However, it has sometimes been the case where, when a command to concurrently function the call function and the voice guidance function is outputted, the function commanded later is prioritized, and the call or the voice guidance are interrupted.

The present invention has been made to solve the above conventional defects, and its object is to provide a hot water supply device, which is able to output an important voice guidance and of which the voice guidance is not interrupted partway and the call is hardly interrupted partway.

### DISCLOSURE OF THE INVENTION

In order to achieve the above object, there is provided a hot water supply device comprising:
a host remote controller having an interphone function section; and
a bath remote controller having an interphone function section capable of establishing a call with the host remote controller, wherein
the host remote controller or the bath remote controller has a voice guidance function section for outputting a voice guidance from the host remote controller and the bath remote controller,
a priority is preparatorily given to voice guidance contents outputted by the voice guidance function section, and,
when a call between the interphone function section of the host remote controller and the interphone function section of the bath remote controller and an output command of a voice guidance by the voice guidance function section concurrently occur, the voice guidance having higher order of priority is outputted from the host remote controller and the bath remote controller preferentially over the call.

In one embodiment of the invention, a voice guidance of a lower order like a voice guidance for confirming switch manipulation of the host remote controller or the bath remote controller is outputted from the host remote controller and the bath remote controller after the call.

In one embodiment of the invention, the voice guidance function section does not output the voice guidance of the lower order from the host remote controller and the bath remote controller after a lapse of a prescribed set time from the output command of the voice guidance that occur concurrently with the call after the call ends.

According to the hot water supply device of the present invention, when a call by the interphone function and an output command of the voice guidance outputted by the voice guidance function concurrently occur, voice guidance of the higher order is outputted. Therefore, the user can listen to the important voice guidance contents.

Moreover, according to the hot water supply device of one embodiment, the voice guidance contents of the lower order can be outputted after the call. Therefore, the voice guidance contents, which are even not so important, can be heard after the call.

Moreover, according to the hot water supply device of one embodiment, the voice guidance of the lower order is not outputted after a lapse of a prescribed set time after the call ends. The above is because the voice guidance of the lower order is the voice for confirming that, for example, switch manipulation of the bath remote controller has been performed, and accordingly there is a low necessity for hearing the voice guidance after a lapse of the prescribed set time.

### BRIEF DESCRIPTION OF THE DRAWINGS

FIG. 1 is a simplified schematic view of a hot water supply device that employs the hot water supply device of the present invention;

FIG. 2 is a simplified schematic view of the hot water supply device; and

FIG. 3 is a flowchart for explaining the functions of the hot water supply device of the present invention.

### DETAILED DESCRIPTION OF THE INVENTION

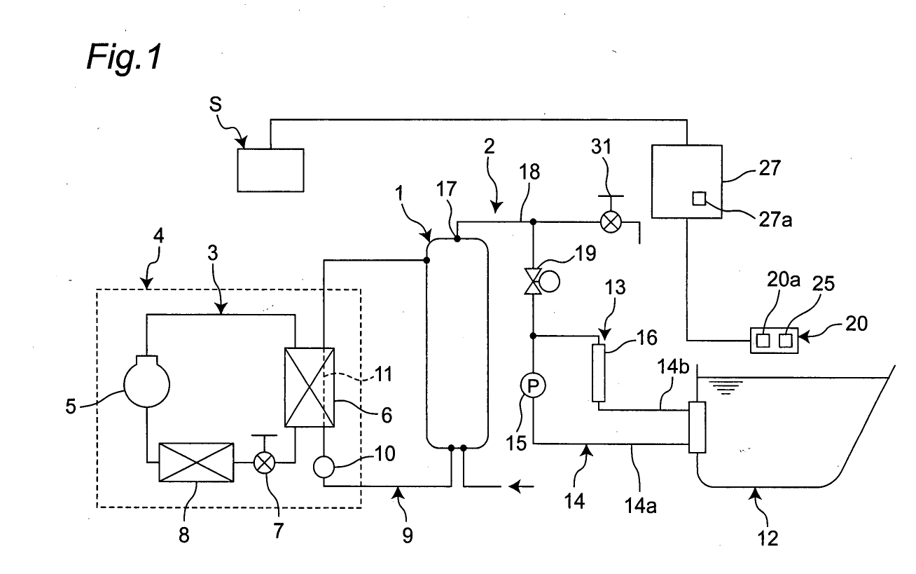

Concrete embodiments of the hot water supply device of the present invention will be described in detail next with reference to the drawings. FIG. 1 is a simplified schematic view of the whole of the hot water supply device. The hot water supply device is a heat pump type water heater including a tank unit 2 that has a hot water reservoir tank 1, a heat source unit (hereinafter referred to as a heat pump unit) 4 that has a refrigeration cycle 3, a control means S for controlling the tank unit 2 and the heat pump unit 4, a host remote controller 27 placed in a kitchen or the like and a bath remote controller 20 placed in a bathroom and serves to heat the water (warm water) in the hot water reservoir tank 1 by the heat pump unit 4.

The refrigeration cycle 3 is constituted by successively connecting a compressor 5, a water heat exchanger 6, an expansion valve 7 and an evaporator 8. Then, the tank unit 2 has the hot water reservoir tank 1 and a circulation passage 9, and a water circulation pump 10 and a heat exchange passage 11 are provided in the circulation passage 9. In this case, the heat exchange passage 11 is constituted of the water heat exchanger 6.

That is, when the compressor 5 is driven and the pump 10 is driven (operated), the reserved water (warm water) flows to the circulation passage 9 from an water outlet provided at the bottom of the hot water reservoir tank 1, and the water passes through the heat exchange passage 11. At the time, the warm water is heated (boiled) by the water heat exchanger 6 and sent back to an upper portion of the hot water reservoir tank 1 from a hot water inlet. By this operation, hot water of a high temperature is reserved in the hot water reservoir tank 1.

The hot water in the hot water reservoir tank 1 is supplied to a bathtub 12 or the like. Moreover, a temperature keeping circulation passage 13 for keeping the temperature of the hot water in the bathtub 12 is connected to the bathtub 12. The temperature keeping circulation passage 13 is constituted of a circulation piping 14, and a pump 15 and a temperature keeping electric heater 16 that are provided in the circulation piping 14. That is, the circulation piping 14 is constructed of a first piping 14a and a second piping 14b. The pump 15 is provided in the first piping 14a, and the temperature keeping electric heater 16 is provided in the second piping 14b. With this arrangement, by driving the pump 15, the hot water in the bathtub 12 is introduced into the first piping 14a of the circulation piping 14, flows from the first piping 14a into the second piping 14b, is heated by the temperature keeping electric heater 16 and is sent back to the bathtub. Then, by continuing the circulation, the hot water in the bathtub 12 is kept at a roughly constant temperature.

Moreover, the temperature keeping circulation passage 13 is connected to a piping 18 connected to a hot water outlet 17 of the hot water reservoir tank 1. An on-off valve 19 is provided in the piping 18. When the on-off valve 19 is in an open state, the hot water of a high temperature in the hot water reservoir tank 1 is supplied to the bathtub 12 via the piping 18 and the temperature keeping circulation passage 13, supplying hot water into the bathtub 12. When the on-off valve 19 is in a closed state, temperature keeping operation is performed, as described above, by circulating the hot water in the bathtub 12 through the temperature keeping circulation passage 13. It is noted that a faucet 31 placed in a kitchen or the like is connected to the piping 18.

Then, in the bathroom in which the bathtub 12 is placed, the bath remote controller 20 is provided on its wall surface. The bath remote controller 20 has an operating function to carry out various operation manipulations and a call function (interphone function). In this case, the interphone function enables conversations between the bath remote controller 20 and the host remote controller 27.

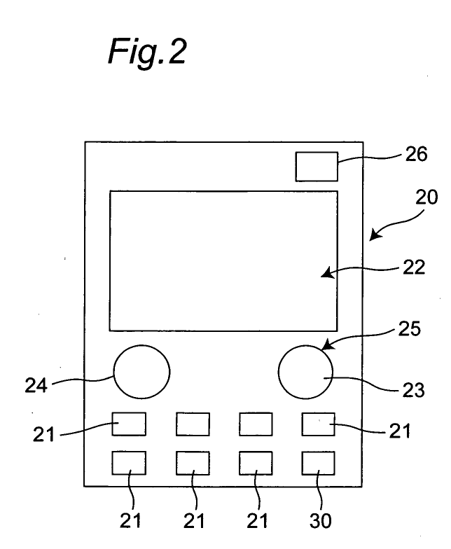

As shown in FIG. 2, the remote controller 20 includes a plurality of manipulating buttons 21, . . . that command various operations, a monitor screen 22, and a call function constituting section 25 as one example of the interphone function section that has a voice generating part (speaker part) 23 and a voice transmitting part (microphone part) 24. It is noted that the numeral 26 in FIG. 2 denotes a power switch.

Moreover, the bath remote controller 20 is connected to the host remote controller 27. Although not illustrated, the host remote controller 27 is provided with a call function constituting section 27a as one example of the interphone function section that has a voice generating part (speaker part) and a voice transmitting part (microphone part) as in the bath remote controller 20.

With this arrangement, when a user inputs a voice to the voice transmitting part 24 of the call function constituting section 25 at the bath remote controller 20, the call signal is transmitted from the voice transmitting part 24 to the host remote controller 27. Then, a voice is generated by the voice generating part of the host remote controller 27 based on the call signal. Conversely, when a user inputs a voice to the voice transmitting part of the host remote controller 27, the call signal is transmitted from the voice transmitting part to the bath remote controller 20. Then, a voice is generated by the voice generating part of the bath remote controller 20 based on the call signal. As described above, conversations between the bath remote controller 20 and the host remote controller 28 are enabled.

Moreover, the bath remote controller 20 has a voice guidance function section 20a for outputting a voice guidance from the host remote controller 28 and the bath remote controller 20. In this case, the function of the voice guidance function section 20a is the function to guide “attention calling”, “information” and so on by a sound. The “attention calling” is a sound representing the “attention calling” issued by the voice generating part (speaker part) 23 of the call function constituting section 25 when, for example, an anomaly occurs in the hot water supply device to give notice of the anomaly or to give notice of the necessity of calling attention to a matter that is not anomalous. The anomaly includes an anomaly on the tank unit 2 side and an anomaly on the heat pump unit 4 side.

Therefore, the hot water supply device has an anomaly detection means for detecting, when an anomaly occurs, the anomaly. For example, when an anomaly occurs in the pumps 10, 15 or the like in the circulation system of the hot water, there is a change in the voltage value of the pump motors, and the anomaly detection means detecting the change is adequate. Regarding the heat pump unit 4, there is an operation to control the temperature of the discharge pipe of the compressor 5 for improving the operating efficiency (COP). For this purpose, the temperature of the discharge pipe of the compressor 5 has been detected by a discharge pipe temperature detection means (for example, a thermistor). However, when the discharge pipe temperature detection means is defective, it is sometimes the case where the discharge pipe temperature detection means indicates a temperature lower than the correct temperature of the discharge pipe. As described above, when the detected discharge pipe temperature is lower, the compressor is to be operated at a very high discharge gas temperature, resulting in decreased COP and reliability of the compressor. That is, an anomaly detection means can be constituted of the discharge pipe temperature detection means.

The user taking a bath is concerned to touch the hot water of a high temperature since the hot water of a high temperature is running in, for example, in the case of high temperature hot water pouring operation to pour some more hot water into the bathtub 12. Therefore, a voice guidance of “attention calling” announcing that “high temperature hot water will run” is outputted in the case of the hot water pouring operation or the like, which is not in the anomaly state of a failure or the like. Further, the voice guidance of “attention calling” announcing that “high temperature hot water will run” is similarly outputted in hot water supply operation and at the time of manipulation for changing the set temperature to a higher temperature side. Moreover, at the time of erroneous manipulation, for example, when the hot water supply temperature setting is performed by a remote controller (e.g., the bath remote controller 20) that does not have priority, the voice guidance of “attention calling” is outputted.

The “information” is a voice guidance like a confirmation message when various settings like, for example, temperature keeping time setting and water supply quantity setting are changed. Voice guidances include such an announcing that “hot water supply will be completed in another five minutes” immediately before (e.g., five minutes before) the completion of hot water supply in “automatic hot water supply” to perform the operation of automatically supplying the bathtub 12 with hot water. Moreover, it is acceptable to give notice of the event that the remaining amount of hot water in the hot water reservoir tank 1 has been reduced as the “information” of voice guidance. When the voice guidances of “attention calling” and “information” are issued, pictures that indicate them may be displayed on the monitor screen 22.

The voice guidance contents are outputted by manually manipulating a switch 30 or on the basis of an output command from the control means S. That is, the voice guidances can be outputted by manually manipulating the switch 30 or outputted on the basis of the output command from the control means S. The hot water supply device can operate in a manual mode or an automatic mode. For example, in the manual mode, various operations are to be performed by manipulating the switch 30. When the switch is manipulated, the voice guidance corresponding to the operation is outputted. Moreover, in the automatic mode, when an anomaly state is detected by the anomaly detection means as described above, the voice guidance of “attention calling” indicating the anomaly is outputted by the output command from the control means S without manipulating the switch.

In this case, the bath remote controller 20 has a storage means (e.g., flash memory), and a voice guidance signal is inputted to the bath remote controller 20 when the switch 30 is manipulated or a command is issued from the control means S. When the voice guidance signal is inputted, the voice guidance signal is once stored in the storage means. As described above, when the voice guidance signal is stored in the storage means, a signal that indicates the storage is inputted to the control section (microcomputer) of the bath remote controller 20. By this operation, the bath remote controller 20 exhibits the voice guidance function.

When various operations by the control means S are performed by operating the switch 30, a sound of the recognition of the voice guidance can be generated when the switch is manipulated. That is, the sound of the recognition of the voice guidance is a sound different from the voice guidance contents, and it is, for example, a buzzer sound or the like outputted when the switch is manipulated. The sound is also included in the “information”.

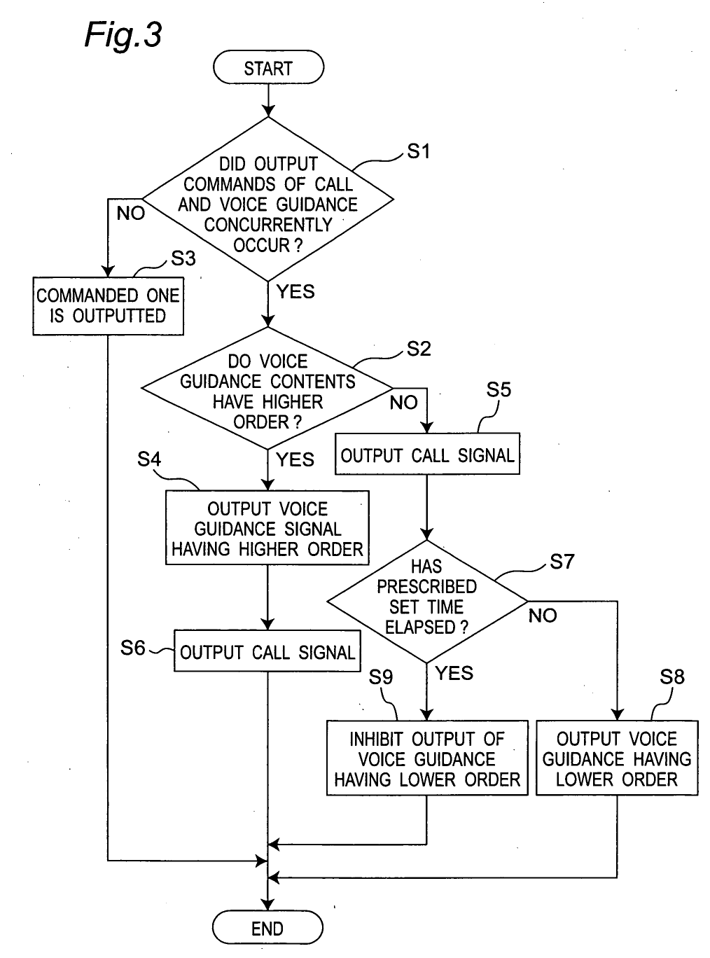

In the hot water supply device constructed as above, it is enabled to issue an operation signal or to issue a call signal by using the bath remote controller 20 provided at the bathroom. That is, it is enabled to produce the functions as shown in the flowchart of FIG. 3. That is, regarding the voice guidance contents in the present hot water supply device, the “attention calling” is superior to the “information”. When the voice guidance contents are of the “attention calling”, the contents are preferential over the call contents. When the voice guidance contents are of the “information”, the call contents are preferential over the voice guidance contents. The function is described below according to the flowchart.

First of all, it is determined in step S1 whether or not output commands of a call and voice guidance concurrently occurred. The program flow proceeds to step S2 when they concurrently occurred, or the program flow proceeds to step S3 when they did not concurrently occur. In step S3, commanded one is outputted, e.g., when output command is call, the call signal is outputted, and when output command is voice guidance, the voice guidance signal is outputted. It is determined in step S2 whether or not the contents of the voice guidance commanded to be outputted is of the higher order. That is, it is determined whether the voice guidance is the “attention calling” or the “information”.

When the voice guidance contents are of the higher order in step S2, the program flow proceeds to step S4 to output the voice guidance. When the output of the voice guidance is completed, the program flow proceeds to step S6 to output the call signal. When the voice guidance contents are not of the higher order in step S2, the program flow proceeds to step S5 to preferentially output the call contents. The program flow proceeds from step S5 to step S7 to measure a lapse of time from the change of various settings like the temperature keeping time setting and the water supply quantity setting by, for example, manipulating the bath remote controller 20. When a prescribed set time has not elapsed from the output command of the voice guidance in step S7, the program flow proceeds to step S8 to output the voice guidance. When the prescribed set time has elapsed from the output command of the voice guidance in step S7, the program flow proceeds to step S9 to inhibit the output of the voice guidance.

In the hot water supply device, when the call by the interphone function and the output command of the voice guidance by the voice guidance function concurrently occur, the voice guidance of the higher order is outputted. Therefore, the user can listen to the important voice guidance contents. Moreover, even when the call by the interphone function and the output command of the voice guidance by the voice guidance function concurrently occur and the voice guidance of the higher order is preferentially outputted, the voice guidance contents of the lower order can be outputted after the call. Therefore, the voice guidance contents, which are even not so important, can be heard after the call.

Moreover, after the call ends, the voice guidance of the lower order is not outputted after a lapse of the prescribed set time from the output command of the voice guidance. That is, the voice guidance of the lower order is a sound mainly for confirming that the switch manipulation of the bath remote controller has been performed. For this reason, there is a low necessity for hearing the voice guidance after a lapse of the prescribed set time from the output command of the voice guidance.

The voice guidance function section 20a, which has been provided for the bath remote controller 20 in the above embodiment, may be provided for the host remote controller.

Although the concrete embodiment of the present invention has been described above, the present invention is not limited to the above embodiment but allowed to be implemented through a variety of changes within the scope of the present invention. For example, although the hot water supply device has been the heat pump type water heater employing the heat pump unit as the heat source in the above embodiment, it may be one that employs another electric heater or the like as the heat source. Moreover, it may be one that has no hot water reservoir tank. Furthermore, the prescribed set time in step S7 of FIG. 3 can arbitrarily be set. Moreover, it is acceptable to place a slave remote controller in a bedroom, a child's room and the like and to enable a call between the slave remote controller and the host remote controller, a call between the slave remote controller and the bath remote controller and a call between slave remote controllers.

1. A hot water supply device comprising:
a host remote controller (27) having an interphone function section (27a); and
a remote controller (20) having an interphone function section (25) capable of establishing a call with the host remote controller (27), wherein
the host remote controller (27) or the remote controller (20) has a voice guidance function section (20a) for outputting a voice guidance from the host remote controller (27) and the remote controller (20),
a priority is preparatorily given to voice guidance contents outputted by the voice guidance function section (20a), and,
when a call between the interphone function section (27a) of the host remote controller (27) and the interphone function section (25) of the remote controller (20) and an output command of a voice guidance by the voice guidance function section (20a) concurrently occur, the voice guidance having higher order of priority is outputted from the host remote controller (27) and the remote controller (20) preferentially over the call.

2. The hot water supply device as claimed in claim 1, wherein
a voice guidance of a lower order like a voice guidance for confirming switch manipulation of the host remote controller (27) or the remote controller (20) is outputted from the host remote controller (27) and the remote controller (20) after the call.

3. The hot water supply device as claimed in claim 1, wherein
the voice guidance function section (20a) does not output the voice guidance of the lower order from the host remote controller (27) and the remote controller (20) after a lapse of a prescribed set time from the output command of the voice guidance that occur concurrently with the call after the call ends.

4. The hot water supply device as claimed in claim 2, wherein
the voice guidance function section (20a) does not output the voice guidance of the lower order from the host remote controller (27) and the remote controller (20) after a lapse of a prescribed set time from the output command of the voice guidance that occur concurrently with the call after the call ends.
